(19) United States
(12) Patent Application Publication
(10) Pub. No.: US 2026/0009932 A1
(43) Pub. Date: Jan. 8, 2026

(54) LENS STRUCTURE

(71) Applicant: Lextar Electronics Corporation, Hsinchu City (TW)

(72) Inventors: Feng-Jung KUO, Hsinchu City (TW); Wei-Yi HSU, Hsinchu City (TW); Jung-Tang CHU, Hsinchu City (TW); Ming-Jing LEE, Hsinchu City (TW)

(21) Appl. No.: 19/260,338

(22) Filed: Jul. 4, 2025

(30) Foreign Application Priority Data
Jul. 4, 2024 (TW) 113125090

(51) Int. Cl. G02B 3/02; G02B 1/04; G02B 3/00

(52) U.S. Cl. CPC G02B 3/02; G02B 1/041; G02B 2003/0093

(57) ABSTRACT

A lens structure is provided. The lens structure includes a body having an upper surface and a lower surface, wherein the lower surface is a plane. The plane has an X direction and a Y direction, and the X direction is orthogonal to the Y direction. The body includes a first part having a first protrusion extending along the Y direction and a second part having a second protrusion extending along the Y direction, wherein the second part is arranged in parallel with the first part along the X direction. There is a depression between the first protrusion and the second protrusion, and the depression extends along the Y direction.

### CROSS REFERENCE TO RELATED APPLICATIONS

This application claims priority of Taiwan Patent Application No. 113125090, filed on Jul. 4, 2024, the entirety of which is incorporated by reference herein.

### BACKGROUND OF THE INVENTION

### Field of the Invention

The present disclosure relates to an optical device, and, in particular, it relates to a lens structure.

### Description of the Related Art

In electronic products, light-emitting diodes (LEDs) are often used as light sources and are paired with various display screens to display images. However, such light sources are usually circular symmetrical light sources, and the images projected by such light sources have weaker light intensity at the edges, thereby causing uneven brightness and reducing display quality. Therefore, how to improve the non-uniformity of the circularly symmetrical light source has become an urgent issue to be solved in the art.

### BRIEF SUMMARY OF THE INVENTION

In some embodiments, a lens structure is provided. The lens structure includes a body having an upper surface and a lower surface, wherein the lower surface is a plane. The plane has an X direction and a Y direction, and the X direction is orthogonal to the Y direction. The body includes a first part having a first protrusion extending along the Y direction and a second part having a second protrusion extending along the Y direction, wherein the second part is arranged in parallel with the first part along the X direction. There is a depression between the first protrusion and the second protrusion, and the depression extends along the Y direction.

The lens structure of the present disclosure may be applied in a variety of electronic products. In order to make the features and advantages of the present disclosure more comprehensible, various embodiments are specially cited hereinafter, together with the accompanying drawings, to be described in detail as follows.

### BRIEF DESCRIPTION OF THE DRAWINGS

FIG. 1 is a schematic diagram showing a projection of an existing circularly symmetrical light source on a display screen.

FIG. 2 is a top view showing the lens structure according to some embodiments of the present disclosure.

FIG. 3 is a stereogram view showing the lens structure according to some embodiments of the present disclosure.

FIG. 4 is another top view showing the lens structure according to some embodiments of the present disclosure.

FIG. 5 is a side view showing the lens structure according to some embodiments of the present disclosure.

FIG. 6 is another side view showing the lens structure according to some embodiments of the present disclosure.

FIGS. 7A and 7B are light pattern diagrams of existing circularly symmetrical light sources.

FIGS. 8A and 8B are light pattern diagrams according to some embodiments of the present disclosure.

### DETAILED DESCRIPTION OF THE INVENTION

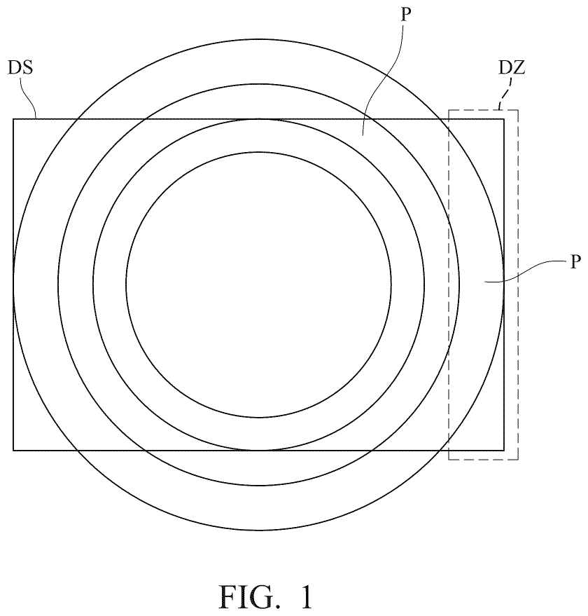

FIG. 1 is a schematic diagram of the projection of an existing circularly symmetrical light source on a display screen (alternatively, it may be referred to as a projection area). As shown in the figure, in some existing electronic products, LEDs are usually used as light sources, and the light pattern emitted by such light sources is circularly symmetrical. However, the display screen DS as a projection target is mostly rectangular. Taking the schematic diagram of FIG. 1 as an example, the projection P (e.g., circle) of the circularly symmetric light source on the display screen DS obviously does not match the display screen DS (e.g., rectangle), especially in the edge area. Therefore, the edge of the display screen DS tends to have a dark zone DZ, causing the image to be blurred or have insufficient brightness at the edge of the display screen DS. In addition, since the illumination of light is inversely proportional to the distance it travels, the brightness of the projection P also decreases gradually from the center of the circle to the outside (such as the multiple concentric circles in FIG. 1), which also causes the brightness of the image to be displayed on the screen DS is not uniform. Therefore, the combination of the circular symmetrical light source and the rectangular display screen DS has a lower display quality.

In order to solve the above technical problems, the present disclosure provides a lens structure for a circularly symmetrical light source. For example, the lens structure of the present disclosure can be disposed on a circularly symmetrical light source by bonding, adsorption, embedding, tight fitting, or other methods known to a person having ordinary skills in the art. Specifically, the lens structure can focus the light source at a specific position of the display screen (or projection area) through a specific surface profile, thereby improving the problem that the existing circular symmetrical light source is obviously not suitable for a rectangular display screen. It should be noted that although LED is used as an example above, the present disclosure is not limited thereto. In practical applications, the lens structure of the present disclosure can be applied to various circularly symmetrical light sources.

In order to reduce the impact on the display, the lens structure of the present disclosure is a high light transmittance lens. In some embodiments, the material of the lens structure may include polymethyl methacrylate (PMMA), polyethylene terephthalate (PET), polycarbonate (PC), combinations thereof, or other suitable materials, but the present disclosure is not limited thereto. In some embodiments, the lens structure of the present disclosure is made of a single material, but the present disclosure is not limited thereto. For example, in some other embodiments, the lens structure may include a lens body and an optical film for improving optical properties, such as an anti-reflection film, a filter film, etc. In some embodiments, the light transmittance of the lens structure may be between 90% and 100%, but the present disclosure is not limited thereto. For example, the light transmittance of the lens structure may be 90%, 92%, 94%, 96%, 98%, 99.9%, or any value or range of the values mentioned above. In some embodiments, the light may be visible light, infrared light, or a combination thereof, but the present disclosure is not limited thereto. In other embodiments, the light may also be ultraviolet light or other suitable light.

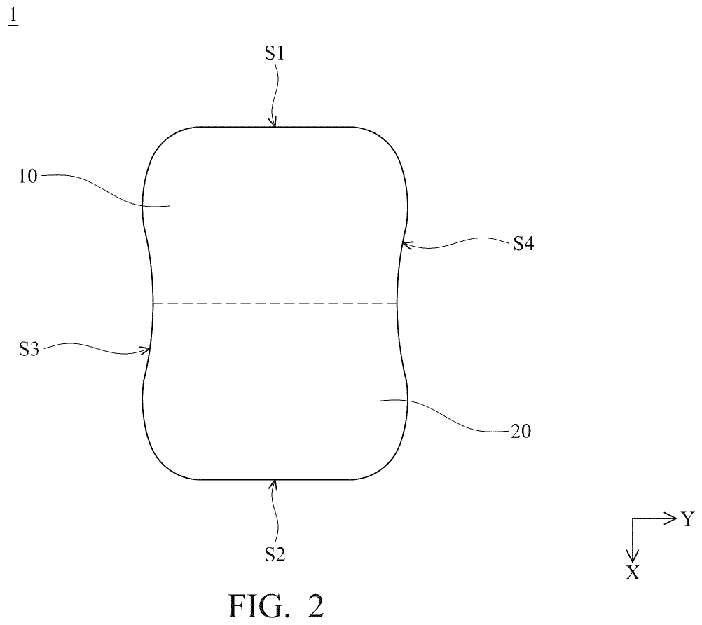

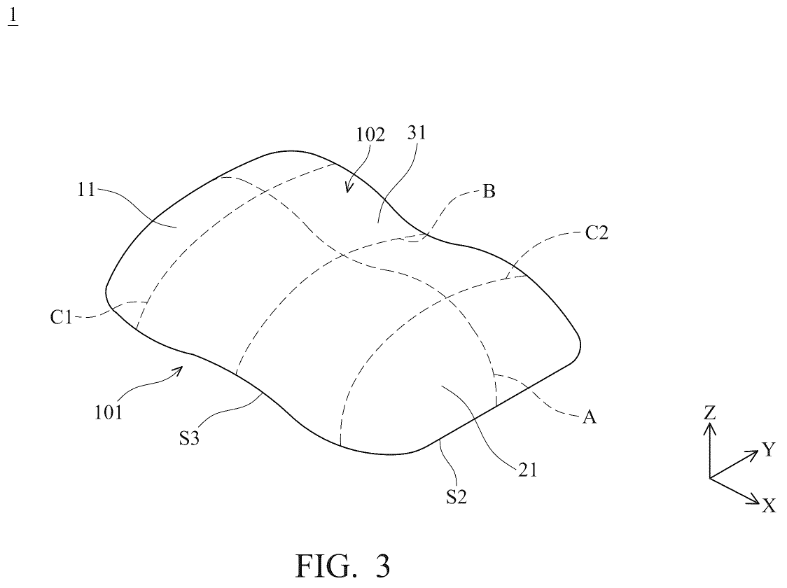

FIGS. 2 to 5 are respectively a top view, a stereoscopic view, another top view, a side view, and another side view of the lens structure according to some embodiments of the present disclosure. As shown in FIGS. 3, 5, and 6, from the surface profile, the surfaces of the lens structure 1 may be roughly divided into a lower surface 101 and an upper surface 102. The lower surface 101 is a substantially flat surface, which is used to be in contact with (e.g., in direct contact with or bonded to) the circular symmetrical light source. On the other hand, the upper surface 102 is a surface with a specific non-flat profile, which focuses the light leaving the lens structure 1 at a specific position on the display screen DS through a specific curvature. In other words, when being disposed on a light source, the lower surface 101 of the lens structure 1 is adjacent to the light source, and the upper surface 102 of the lens structure 1 is facing away from the light source. The light source enters the lens structure from the lower surface 101 of the lens structure 1 and is focused on the display screen DS through the upper surface 102 of the lens structure 1.

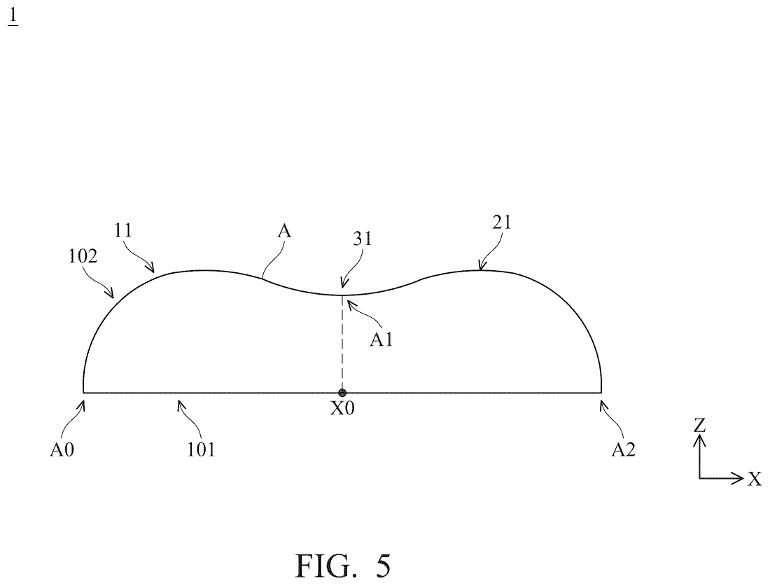

As shown in FIGS. 2 and 3, from a three-dimensional structural perspective, the lens structure 1 includes a first part 10 and a second part 20. The first part 10 has a first protrusion 11 extending along the Y direction. The second part 20 has a second protrusion 21 extending along the Y direction, and the second part 20 is arranged in parallel with the first part 10 along the X direction that is orthogonal to the Y direction. Among them, there is a depression 31 between the first protruding portion 11 and the second protruding portion 21, and the depression 31 extends along the Y direction. As shown in FIG. 5, two sides of the lens structure 1 protrude upward to form peaks (i.e., the first protrusion 11 and the second protrusion 21), and the space between the two peaks collapses downward to form a valley (that is, depression 31). In the following, the lens structure will be described with some definitions to more clearly understand the spatial variation of the profile of the lens structure.

As shown in FIG. 2 and FIG. 3, in some embodiments, a boundary between the lower surface 101 and the upper surface 102 is defined as an edge. In some embodiments, the edge includes a first straight edge S1, a second straight edge S2, a first curved edge S3, and a second curved edge S4. In some embodiments, the first straight edge S1 is located on a side of the first part 10 facing away from the second part 20, and the second straight edge S2 is located on a side of the second part 20 facing away from the first part 10. In some embodiments, the first straight edge S1 and the second straight edge S2 are symmetrical to each other and have substantially the same length. In some embodiments, the first curved edge S3 is located between two adjacent endpoints of the first straight edge S1 and the second straight edge S2, and the second curved edge S4 is located between the other two adjacent endpoints of the first straight edge S1 and the second straight edge S2. In some embodiments, the first curved edge S3 and the second curved edge S4 are symmetrical to each other and have substantially the same length.

In some embodiments, there are chamfers or rounded corners between the first straight edge S1 and the first curved edge S3 and between the first straight edge S1 and the second curved edge S4, and/or there are chamfers or rounded corners between the second straight edge S2 and the first curved edge S3 and between the second straight edge S2 and the second curved edge S4, thereby avoiding stress concentration on the corners of the lens structure 1.

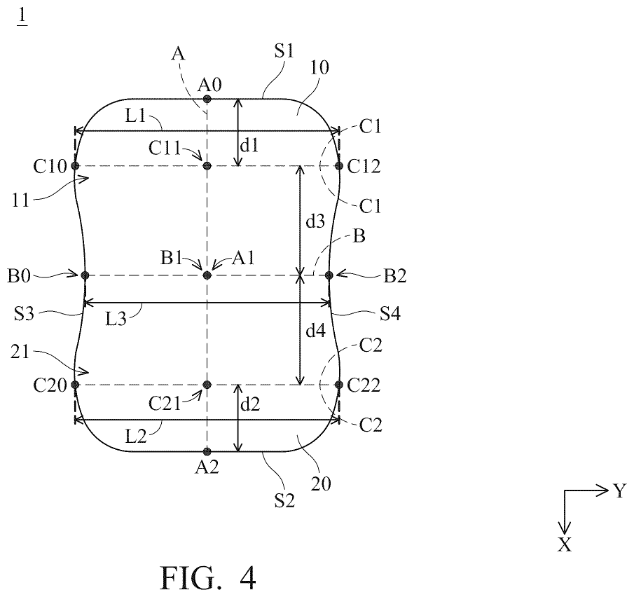

As shown in FIG. 4, in some embodiments, a first endpoint A0 is defined on the first part 10, and the first straight edge S1 passes through the first endpoint A0. For example, the first endpoint A0 is at the center point of the first straight edge S1, but the present disclosure is not limited thereto. In some embodiments, a center point A1 is defined between the first part 10 and the second part 20. For example, the center point A1 is at the center point between the first part 10 and the second part 20, but the present disclosure is not limited thereto. In some embodiments, a second endpoint A2 is defined on the second part 20, and the second straight edge S2 passes through the second endpoint A2. For example, the second endpoint A2 is at the center point of the second straight edge S2, but the present disclosure is not limited thereto.

As shown in FIGS. 4 and 5, in some embodiments, a first central surface contour line A along the X direction may be further defined by the first endpoint A0, the center point A1, and the second endpoint A2. Among them, the first central surface contour line A passes through the first endpoint A0, the central point A1, and the second endpoint A2 in sequence. In some embodiments, the lens structure 1 is bilaterally symmetric along the first central surface contour line A. In some embodiments, the first central surface contour line A satisfies Z=−0.1209X⁶+0.0105X⁵−0.1909X⁴−0.0243X³+0.3506X²+0.0129X+0.61, wherein −1.32≤X≤1.32, and 0≤Z≤0.8. When observed from a side (e.g., the curved edge S3) of the lens structure 1, the first central surface contour line A has a contour as shown in FIG. 5. In some embodiments, the origin of the coordinate axis (i.e., coordinate (0,0)) is the point X0 in FIG. 5, and the point X0 is located at the center of the connecting line of the first endpoint A0 and the second endpoint A2.

As shown in FIG. 4, in some embodiments, a first endpoint C10 is defined on the first protrusion 11, and the first curved edge S3 passes through the first endpoint C10. For example, the first endpoint C10 is located on the first curved edge S3 and on the center line of the first protrusion 11 along the Y direction, but the present disclosure is not limited thereto. In some embodiments, a center point C11 is defined on the first protrusion 11, and the center point C11 is at the center point of the first protrusion 11, but the present disclosure is not limited thereto. In some embodiments, a second endpoint C12 is defined on the first protrusion 11, and the second curved edge S4 passes through the second endpoint C12. For example, the second endpoint C12 is located on the second curved edge S4 and on the center line of the first protrusion 11 along the Y direction, but the present disclosure is not limited thereto.

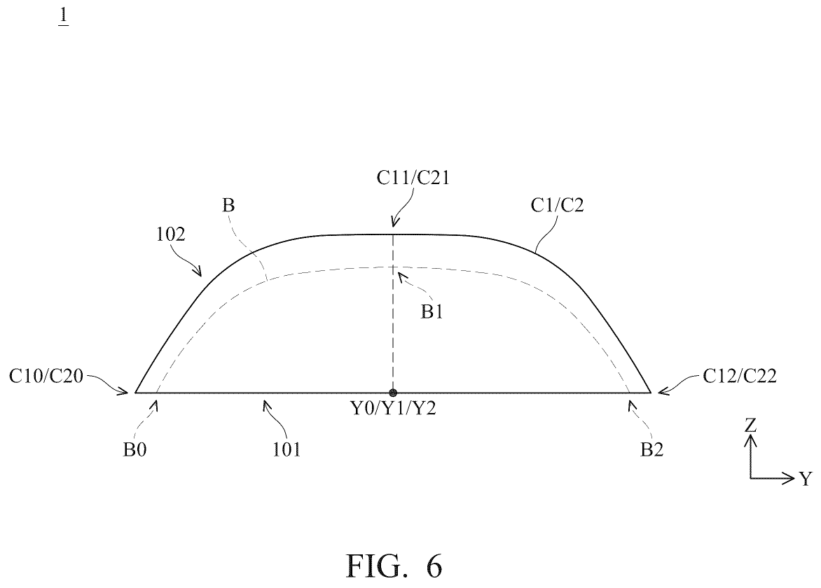

As shown in FIGS. 4 and 6, in some embodiments, a second central surface contour line C1 along the Y direction may be further defined by the first endpoint C10, the center point C11, and the second endpoint C12. In some embodiments, the first protrusion 11 is vertically symmetrical along the second central surface contour line C1. In some embodiments, the second central surface contour line C1 satisfies Z=0.5128Y⁶−2E−14Y⁵−1.2787Y⁴+2E−14Y³+0.0415Y²−5E−15Y+0.7204 on the YZ plane formed by the Y direction and the Z direction, wherein −0.99≤Y≤0.99, and 0≤Z≤0.8. When observed from another side (e.g., a straight edge) of the lens structure 1, the second central surface contour line C1 has a contour as shown in FIG. 6. In some embodiments, the origin of the coordinate axis (i.e., coordinate (0,0)) is the point Y1 in FIG. 6, and the point Y1 is located at the center of the connecting line of the first endpoint C10 and the second endpoint C12.

As shown in FIG. 4, in some embodiments, a first endpoint C20 is defined on the second protrusion 21, and the first curved edge S3 passes through the first endpoint C20. For example, the first endpoint C20 is located on the first curved edge S3 and on the center line of the second protrusion 21 along the Y direction, but the present disclosure is not limited thereto. In some embodiments, a center point C21 is defined on the second protrusion 21, and the center point C21 is at the center point of the second protrusion 21, but the present disclosure is not limited thereto. In some embodiments, a second endpoint C22 is defined on the second protrusion 21, and the second curved edge S4 passes through the second endpoint C22. For example, the second endpoint C22 is located on the second curved edge S4 and on the center line of the second protrusion 21, but the present disclosure is not limited thereto.

As shown in FIGS. 4 and 6, in some embodiments, a third central surface contour line C2 along the Y direction may be further defined by the first endpoint C20, the center point C21, and the second endpoint C22. In some embodiments, the second protrusion 21 is vertically symmetrical along the third central surface contour line C2. In some embodiments, the third central surface contour line C2 satisfies Z=0.5128Y⁶−2E−14Y⁵−1.2787Y⁴+2E−14Y³+0.0415Y²−5E−15Y+0.7204 on the YZ plane formed by the Y direction and the Z direction, wherein-0.99≤Y≤0.99, and 0≤Z≤0.8. When observed from another side (e.g., a straight edge) of the lens structure 1, the third central surface contour line C2 has a contour as shown in FIG. 6. In some embodiments, the origin of the coordinate axis (i.e., coordinate (0,0)) is the point Y² in FIG. 6, and the point Y² is located at the center of the connecting line of the first endpoint C20 and the second endpoint C22.

In some embodiments, a first endpoint B0 is defined on the depression 31, and the first curved edge S3 passes through the first endpoint B0. For example, the first endpoint B0 is at the center point of the first curved edge S3, but the present disclosure is not limited thereto. In some embodiments, a center point B1 is defined on the depression 31, and the center point B1 is at the center point of the depression 31. In some embodiments, the center point B1 is the same point as the center point A1 mentioned above. In some embodiments, a second endpoint B2 is defined on the depression 31, and the second curved edge S4 passes through the second endpoint B2. For example, the second endpoint B2 is at the center point of the second curved edge S4, but the present disclosure is not limited thereto.

As shown in FIG. 4 and FIG. 6, in some embodiments, a fourth central surface contour line B along the Y direction may be further defined by the first endpoint B0, the center point B1, and the second endpoint B2. In some embodiments, the depression 31 is vertically symmetrical along the fourth central surface contour line B. In some embodiments, the fourth central surface contour line satisfies Z=0.3341Y⁶−1E−14Y⁵−1.0993Y⁴+1E−14Y³−0.0047Y²−2E−15Y+0.6 on the YZ plane formed by the Y direction and the Z direction, wherein −0.92≤Y≤0.92, and 0≤Z≤0.6. When observing the cross section of the lens structure 1, the fourth central surface contour line B has a contour as shown by the dotted line in FIG. 6. In some embodiments, the origin of the coordinate axis (i.e., coordinate (0,0)) is the point Y0 in FIG. 6, and the point Y0 is located at the center of the connecting line of the first endpoint B0 and the second endpoint B2.

As shown in FIG. 4, in some embodiments, the first protrusion 11 and the second protrusion 21 are symmetrical to each other. Therefore, the shortest distance d1 between the second central surface contour line C1 and the first straight edge S1 is equal to the shortest distance d2 between the third central surface contour line C2 and the second straight edge S2. The shortest distance d3 between the second central surface contour line C1 and the fourth central surface contour line B is equal to the shortest distance d4 between the third central surface contour line C2 and the fourth central surface contour line B. The length L1 of the second central surface contour line C1 is equal to the length L2 of the third central surface contour line C2.

In some embodiments, the shortest distance d1 between the second central surface contour line C1 and the first straight edge S1 may be equal to the shortest distance d3 between the second central surface contour line C1 and the fourth central surface contour line B1, and the shortest distance d2 between the third central surface contour line C2 and the second straight edge S2 may be equal to the shortest distance d4 between the third central surface contour line C2 and the fourth central surface contour line B, but the present disclosure is not limited thereto. In some embodiments, the length L1 of the second central surface contour line C1 and the length L2 of the third central surface contour line C2 are both greater than the length L3 of the fourth central surface contour line B.

In some embodiments, the applicable angle range of the lens structure 1 is between 90 degrees and 140 degrees, but the present disclosure is not limited thereto. For example, the applicable angle of the lens structure 1 may be 90 degrees, 100 degrees, 110 degrees, 120 degrees, 130 degrees, 140 degrees, or any value or range of the values mentioned above. In some embodiments, the lens structure 1 may be applied to the light source of a home security camera, but the present disclosure is not limited thereto.

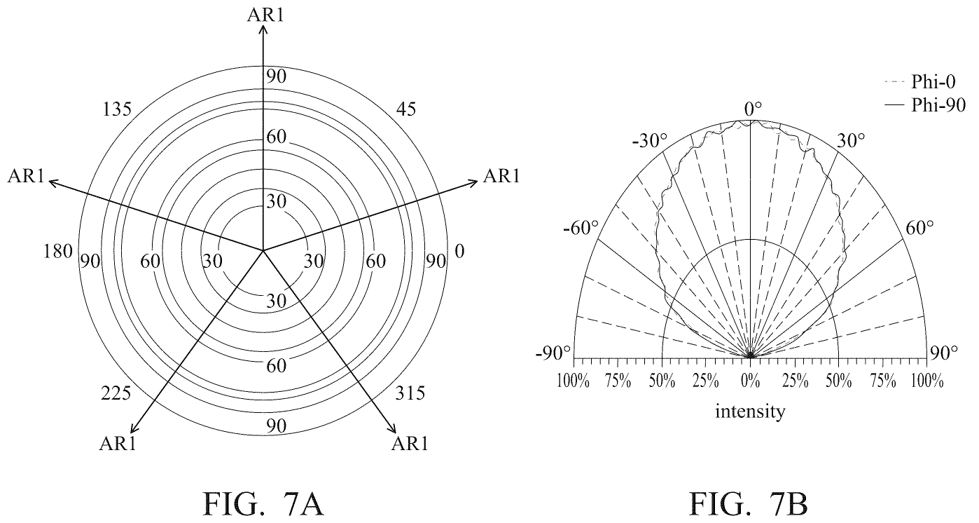

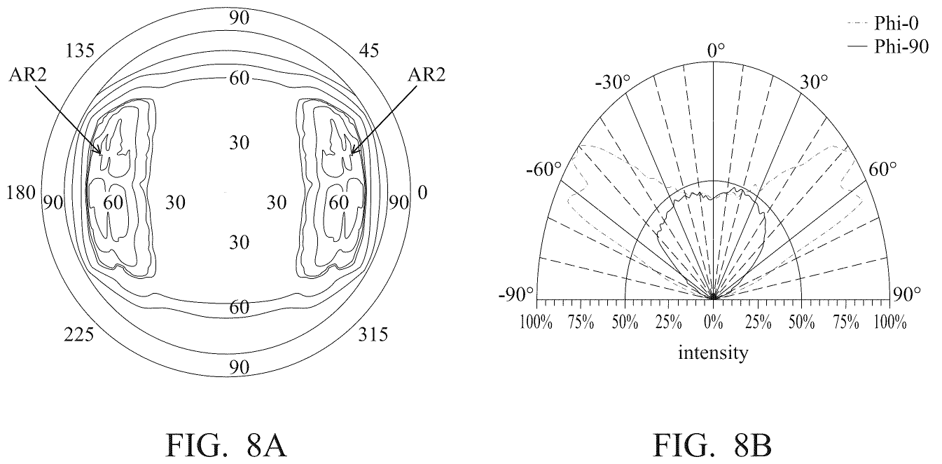

As described above, the lens structure 1 with the above-mentioned profile may effectively make the circular symmetrical light source more compatible with the rectangular display screen DS. FIGS. 7A and 7B are light pattern diagrams of an existing circularly symmetrical light source, and FIGS. 8A and 8B are light pattern diagrams of the lens structure according to some embodiments of the present disclosure. As shown in FIGS. 7A and 7B, from the light pattern of the existing circularly symmetrical light source, the light intensity gradually decreases from the center to the outside (that is, along the direction indicated by the arrow AR1 in the figure, the light intensity gradually weakens). If this light source is irradiated on the display screen DS, the uniformity of the resulting projection is only 13.6%. In contrast, when the lens structure 1 of the present disclosure is disposed on the same circularly symmetrical light source, from the light pattern diagrams shown in FIG. 8A and FIG. 8B, the positions where the light intensity is the highest are concentrated on the two side (that is, the area indicated by the arrow AR2 in the figure has the highest light intensity). If this light source is irradiated on the display screen DS, the uniformity of the resulting projection may be as high as 44.1%. Therefore, the lens structure 1 provided by the present disclosure may significantly improve the problem of mismatch between the existing circularly symmetrical light source and the display screen, and provide better display quality.

The foregoing outlines features of several embodiments of the present disclosure, so that a person of ordinary skill in the art may better understand the aspects of the present disclosure. A person of ordinary skill in the art should appreciate that, the present disclosure may be readily used as a basis for designing or modifying other processes and structures for carrying out the same purposes and/or achieving the same advantages of the embodiments introduced herein. A person of ordinary skill in the art should also realize that such equivalent constructions do not depart from the spirit and scope of the present disclosure, and that they may make various changes, substitutions, and alterations herein without departing from the spirit and scope of the present disclosure.

What is claimed is:

1. A lens structure, comprising:
a body having: an upper surface and a lower surface, wherein the lower surface is a plane;
a first part having a first protrusion extending along a Y direction; and
a second part having a second protrusion extending along the Y direction, wherein the second part is arranged in parallel with the first part along an X direction orthogonal to the Y direction,
wherein a depression is between the first protrusion and the second protrusion, and the depression extends along the Y direction.

2. The lens structure as claimed in claim 1, wherein a first endpoint of the first part, a center point between the first part and the second part, and a second endpoint of the second part define a first central surface contour line along the X direction, and the first central surface contour line satisfies Z=−0.1209X⁶+0.0105X⁵−0.1909X⁴−0.0243X³+0.3506X²+0.0129X+0.61 on an XZ plane formed by the X direction and a Z 14 direction, wherein −1.32≤X≤1.32, 0≤Z≤0.8, and the Z direction is orthogonal to the X direction and the Y direction.

3. The lens structure as claimed in claim 2, wherein the first part has a first straight edge facing away from the second part, and the first straight edge passes through the first 18 endpoint, wherein the second part has a second straight edge facing away from the first part, and the second straight edge passes through the second endpoint.

4. The lens structure as claimed in claim 3, wherein the first endpoint is at a center of the first straight edge, and the second endpoint is at a center of the second straight edge.

5. The lens structure as claimed in claim 1, wherein a first endpoint of the first protrusion, a center point of the first protrusion, and a second endpoint of the first protrusion define a second central surface contour line along the Y direction, and the second central surface contour line satisfies Z=0.5128Y⁶−2E−14Y⁵−1.2787Y⁴+2E−14Y³+0.0415Y²−5E−15Y+0.7204 on a YZ plane formed by the Y direction and a Z direction, wherein −0.99≤Y≤0.99, 0≤Z≤0.8, and the Z direction is orthogonal to the X direction and the Y direction.

6. The lens structure as claimed in claim 5, wherein the first protrusion is vertically symmetrical along the second central surface contour line.

7. The lens structure as claimed in claim 1, wherein a first endpoint of the second protrusion, a center point of the second protrusion, and a second endpoint of the second protrusion define a third central surface contour line along the Y direction, and the third central surface contour line satisfies Z=0.5128Y⁶−2E−14Y⁵−1.2787Y⁴+2E−14Y³+0.0415Y²−5E−15Y+0.7204 on a YZ plane formed by the Y direction and a Z direction, wherein −0.99≤Y≤0.99, 0≤Z≤0.8, and the Z direction is orthogonal to the X direction and the Y direction.

8. The lens structure as claimed in claim 7, wherein the second protrusion is vertically symmetrical along the third central surface contour line.

9. The lens structure as claimed in claim 1, wherein a first endpoint of the depression, a center point of the depression, and a second endpoint of the depression define a fourth central surface contour line along the Y direction, and the fourth central surface contour line satisfies Z=0.3341Y⁶−1E−14Y⁵−1.0993Y⁴+1E−14Y³−0.0047Y²−2E−15Y+0.6 on a YZ plane formed by the Y direction and a Z direction, wherein −0.92≤Y≤0.92, 0≤Z≤0.6, and the Z direction is orthogonal to the X direction and the Y direction.

10. The lens structure as claimed in claim 9, wherein the depression is vertically symmetrical along the fourth central surface contour line.

11. The lens structure as claimed in claim 1, wherein the first protrusion has a second central surface contour line along the Y direction, the second protrusion has a third central surface contour line along the Y direction, and a length of the second central surface contour line is equal to a length of the third central surface contour line.

12. The lens structure as claimed in claim 1, wherein the first protrusion has a second central surface contour line along the Y direction, the second protrusion has a third central surface contour line along the Y direction, the depression has a fourth central surface contour line along the Y direction, and a length of the second central surface contour line and a length of the third central surface contour line are both greater than a length of the fourth central surface contour line.

13. The lens structure as claimed in claim 12, wherein a distance between the second central surface contour line and the fourth central surface contour line is equal to a distance between the third central surface contour line and the fourth central surface contour line.

14. The lens structure as claimed in claim 10, wherein a side of the first part facing away from the second part has a first straight edge, a side of the second part facing away from the first part has a second straight edge, and a distance between the second central surface contour line and the first straight edge is equal to a distance between the third central surface contour line and the second straight edge.

15. The lens structure as claimed in claim 1, wherein the body has a first straight edge, a second straight edge, a first curved edge, and a second curved edge, the first curved edge is located between two adjacent endpoints of the first straight edge and the second straight edge, and the second curved edge is located between the other two adjacent endpoints of the first straight edge and the second straight edge.

16. The lens structure as claimed in claim 15, wherein chamfers or rounded corners are between the first straight edge and the first curved edge and between the first straight edge and the second curved edge, and/or chamfers or rounded corners are between the second straight edge and the first curved edge and between the second straight edge and the second curved edge.

17. The lens structure as claimed in claim 15, wherein the first straight edge and the second straight edge are symmetrical to each other and have substantially the same length.

18. The lens structure as claimed in claim 15, wherein the first curved edge and the second curved edge are symmetrical to each other and have substantially the same length.

19. The lens structure as claimed in claim 1, wherein a material of the lens structure includes polymethyl methacrylate (PMMA), polyethylene terephthalate (PET), polycarbonate (PC), or combinations thereof.

20. The lens structure as claimed in claim 1, wherein a light transmittance of the lens structure is between 90% and 100%.
